(19) United States
(12) Patent Application Publication
(10) Pub. No.: US 2024/0420384 A1
(43) Pub. Date: Dec. 19, 2024

(54) Selectively Applying A Night Mode Color Process On A Computing Device Display

(71) Applicant: QUALCOMM Incorporated, San Diego, CA (US)

(72) Inventors: Sumit GEMINI, Delhi (IN); Nikhil Kumar KANSAL, San Diego, CA (US)

(21) Appl. No.: 18/335,327

(22) Filed: Jun. 15, 2023

(51) Int. Cl. G06T 11/00

(52) U.S. Cl. CPC G06T 11/001; G06T 2200/24

(57) ABSTRACT

Embodiments may include a computing device configured with a display device, a display processor configured to identify a region of interest and a remainder region in a frame for display by the display device, and a composer module, coupled to the display device and the display processor, and configured to apply a night mode color process to the remainder region and not to the region of interest, and to provide a composition of the remainder region and the region of interest to the display device for presentation.

### BACKGROUND

Computing devices such as smartphones, tablets, and others often include a touchscreen device capable of display functions and receiving user input. To reduce eye strain when such devices are used in dark or low-light environments, computing device displays can be configured to shift the colors displayed by the display device away from blue light, to emit warmer or more amber-hued light. However, the computing device display applies this color shift to an entire frame being displayed on the display device, regardless of content. When the color shift is applied to a color image or video on the display, the colors of the resulting image or video are distorted, reducing the quality of displayed images, and potentially rendering image features imperceptible.

### SUMMARY

Various aspects include methods and computing devices configured to perform the methods for selectively applying a night mode color process on a computing device display. Various aspects may include identifying a region of interest and a remainder region in a frame for display by the computing device display, applying, by a composer module of the computing device, a night mode color process to the remainder region of the frame and not to the region of interest, and presenting a composition of the region of interest and the non-image region on the computing device display. Some aspects may include applying a normal color process to the region of interest.

Some aspects may include sending information identifying the region of interest of the frame to a composer module. In such aspects, applying a normal color process to the region of interest of the frame may include performing, by the composer module, regional post-processing on the identified region of interest of the frame using the information identifying the region of interest of the frame. In some aspects, identifying the region of interest of the frame may include applying a machine learning model to the frame for display to identify the region of interest of the frame, in which the machine learning model is trained to identify regions of images that users prefer to view in normal color mode.

Some aspects may include generating the frame for display by the computing device display, in which identifying the region of interest and the remainder region is performed on the generated frame. In some aspects, applying a normal color process to the region of interest of the frame may include applying the normal color process in response to receiving a user input. In some aspects, applying a normal color process to the region of interest of the frame may include applying the normal color process in response to receiving a user input on a portion of the display device presenting the region of interest.

Further aspects may include a computing device having a processor configured to perform one or more operations of any of the methods summarized above. Further aspects may include a non-transitory processor-readable storage medium having stored thereon processor-executable instructions configured to cause a processor of a computing device to perform operations of any of the methods summarized above. Further aspects include a computing device having means for performing functions of any of the methods summarized above. Further aspects include a system on chip for use in a computing device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A-1C illustrate an example computing device 100 suitable for implementing various embodiments.

FIG. 2 is a component block diagram illustrating an example computing system suitable for implementing various embodiments.

FIG. 3 is a functional block diagram of an example computing device suitable for implementing various embodiments.

FIG. 4A illustrates a method for selectively applying a night mode color process on a display device of a computing device according to various embodiments.

FIGS. 4B and 4C illustrate operations that may be performed as part of the method for selectively applying a night mode color process on a display device of a computing device according to various embodiments.

FIG. 5 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include systems and methods for selectively applying a night mode color process to selected portions of images presented on a computing device display (referred to herein as a “display” or “display device”). Various embodiments may improve the user experience with a computing device by improving the quality of portions of images rendered on the display of the computing device while in night mode, in particular by selectively applying such night mode color process to only a portion of a frame for display by the display device. In some embodiments, the computing device may apply a normal color process to selected or identified region of interest portion of the frame, such as an image or portion of an image that appears more pleasing to users when rendered with normal color processing.

The term “computing device” is used herein to refer to any one or all of cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., gaming controllers, music and video players, satellite radios, etc.), wireless-network enabled Internet of Things (IoT) devices including smart meters/sensors, router devices, industrial manufacturing equipment, large and small machinery and appliances for home or enterprise use, computing devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

To reduce eye strain during use of computing devices in dark or low-light environments, computing device displays may be configured to shift displayed away from blue light colors to emit “warmer” or more amber-hued light. This type of color processing is referred to herein as a “night mode color process,” but is sometimes referred to as a “night light” mode, “night shift” mode, or “dark mode.” The night mode color process may provide benefits to users, such as being easier to view in low light conditions and reducing the tendency of computer displays to interrupt sleep patterns.

Conventionally, the display device of a computing device applies the night mode color process to an entire frame being displayed on the display device, regardless of content. Further, typical computing devices are only configured to allow the enablement or disablement of the night mode color process.

This conventional application of the night mode color process to the entire display or frame can impact the user experience. When the night mode color process is applied to a static image or video on the display, which typically include many colors, the colors of the resulting image or video are distorted, reducing the quality of displayed images. It some cases, such color distortion may render certain image features imperceptible to users.

Various embodiments include methods and computing devices configured to perform the methods for selectively applying a night mode color process on a computing device display. Various embodiments may include identifying a region of interest and a remainder region in a frame for display by the computing device display, applying, by a composer module of the computing device, a night mode color process to the remainder region of the frame and not to the region of interest, and presenting a composition of the region of interest and the non-image region on the computing device display. In some embodiments, the computing device may apply a normal color process to the region of interest.

For example, a frame for display may include a first region with an image or video that is best viewed in full color mode (e.g., an animal or persons face), and a second region including background images (e.g., featureless background), boarder colors or text the viewing of which is not impacted by night mode color shifts. In some embodiments, the display processor of the computing device may identify the first region (with the image or video) as a “region of interest,” and may identify the second region (e.g., background, boarder or text) as the “remainder region.” The composer module of the computing device may apply the night mode color process to the remainder region, but avoid applying the night mode color process to the region of interest including an image or video. The display device of a computing device may render a composition of the remainder region in which the night mode color process has been applied, and the image or video region to which the night mode color process has not been applied. In some embodiments in which the night mode color process is applied to the entire display, the composer module may then apply normal color processing to the identified region of interest (e.g., image or portion of an image or video) to return the region of interest to normal colors. In this manner, the computing device may present the remainder region with colors configured to reduce eye strain, while presenting the image or video region with its original colors.

In some embodiments, the display processor may be configured to send information identifying the image region of the frame to the composer module. In such embodiments, the composer module may perform regional post-processing on the identified image region of the frame using the information identifying the region of interest of the frame, such as an image or portion of an image in the frame. In some embodiments, the display processor may generate the frame for display by the display device, and identify the region of interest and the remainder region on the generated frame.

In some embodiments, the display processor may identify the region of interest of the frame by applying a machine learning model to the frame for display to identify the region of interest of the frame. Such a machine learning model may be trained to identify regions of images that users typically prefer to view in normal color mode. For example, the machine learning model may be trained on a training data set including a large number of display frames of various content with a truth set identifying regions within the frames that users have selected for normal color rendering.

In some embodiments, the region of interest may be indicated by a user input and the composer module may apply the normal color process (or not apply the night mode process) to the region of interest in response to receiving the user input. In some embodiments, a user input may enable or disable operations for selectively applying the night mode color process on a computing device globally. In some embodiments, a user may provide an input on a portion of a touch-sensitive display (touch screen display) to identify the region of interest. For example, a user may provide an input, such as a touch, tap or touch gesture (e.g., sketching a loop around a portion of the image), directly on an image or video being displayed by the computing device. Such a user input may prompt the composer module to enable or disable applying the night mode color process to the selected image or video.

Various embodiments improve the user experience with a computing device by enabling selective application of night mode color processes to one or more portions of a frame for display by the computing device, enabling users to view image portions in normal color mode. Enabling computing devices to selectively apply normal colors to a portions of a frame reduces color distortion of such portions of the frame, improving the presentation of such image content while enabling the rest of the display to exhibit the color shifts of night mode operation. Enabling computing devices to selectively apply a night mode color process to one or more portions of a frame enables the computing device to present some frame region(s) with colors configured to reduce eye strain, and two percent other frame region(s), such as a region with image or video region, with its original, undistorted colors.

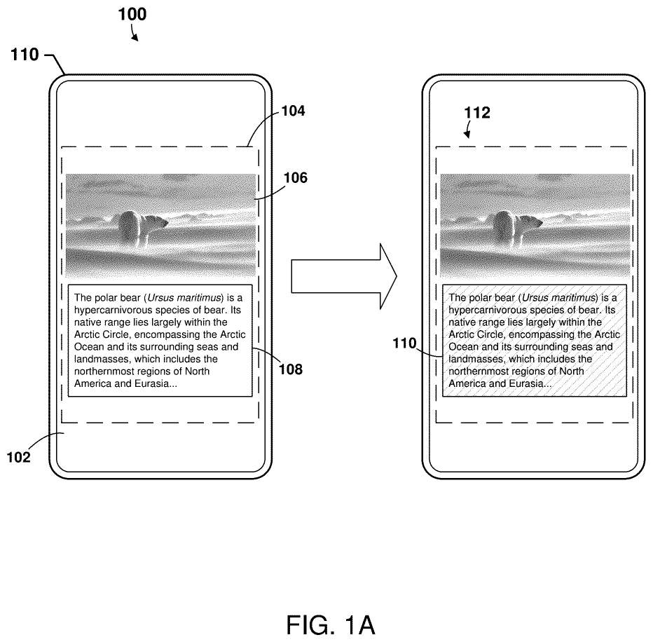

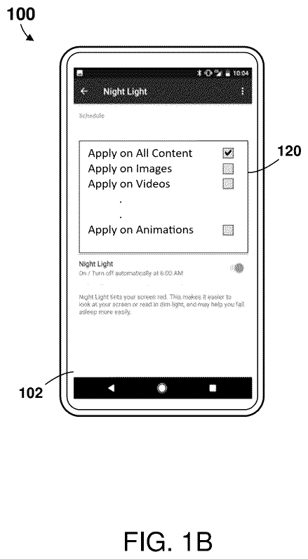

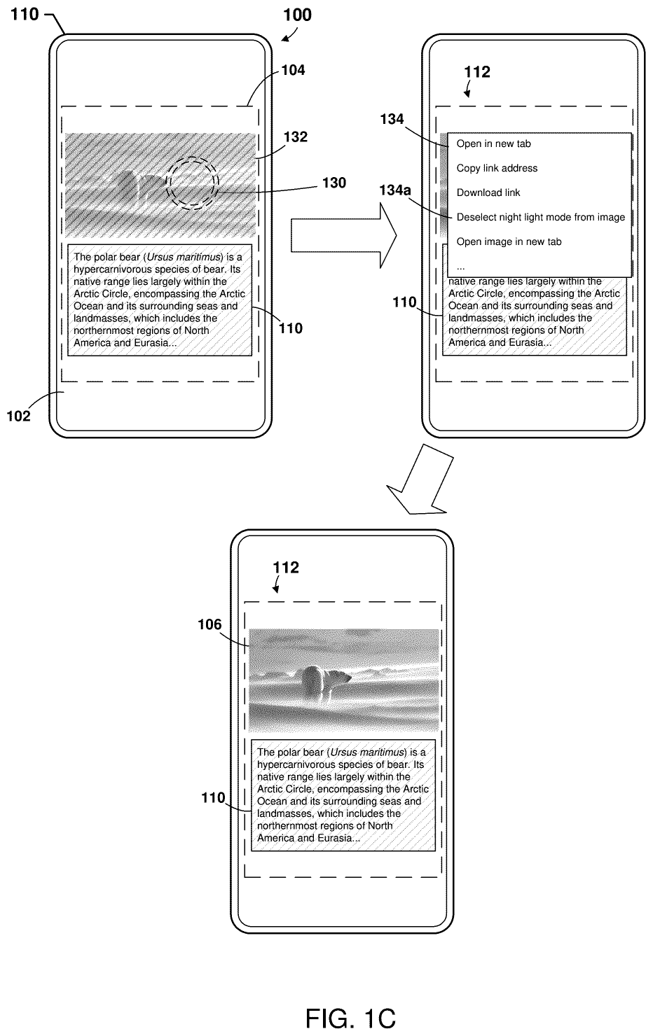

FIGS. 1A-1C illustrate an example of various embodiments presented on a computing device 100. Referring to FIG. 1A, the computing device 100 may include a body 110 that supports a display 102 (a display device). The display 102 may incorporate a touch sensor device to form a touchscreen display. The touch sensor may be configured to detect a change in capacitance at a location where the sensor is touched (or nearly touched) by an object, particularly be a user's fingers, thumb, or hand.

Content presented on the display 102 may include a frame 104. The frame 104 may include a region of interest 106 and a remainder region 108. As one example, the region of interest 106 may include an image or video, and the remainder region 108 may include text. In various embodiments, a display processor of the computing device 100 may identify the region of interest 106 as an image or feature that is best viewed in normal colors and the remainder region 108 as portions that do not need normal color rendering in low light conditions. A composer module of the computing device 100 may apply a night mode color process to the remainder region 108 and not to the region of interest 106. The composer module may provide a composition 112 of a remainder region 108 to which the night mode color process has been applied 110, and the region of interest 106, to which the night mode color process has not been applied, to the display device for presentation. In some embodiments, the composer module may apply a normal color process to the region of interest 106.

Referring to FIG. 1B, in some embodiments, the composer module of the computing device 100 may selectively apply the night mode color process in response to receiving a user input. For example, the computing device 100 may be configured to provide a user interface element 120 that includes options for selectively applying a night mode color process. According to such options, the composer module may apply the night mode color process to, for example, “all content” (e.g., “Apply on All Content”), which may include static images, video, animations, etc., or the composer module may apply the night mode color process to images (e.g., “Apply on Images”), videos (e.g., “Apply on Videos”), animation (e.g., “Apply on Animations”), and/or the like, according to selected options.

Referring to FIG. 1C, in some embodiments, the composer module of the computing device 100 may selectively apply the night mode color process to the region of interest in response to receiving a user input on a portion of the display device presenting the region of interest. For example, the display device 102 may present the remainder region to which the night mode color process has been applied 110, and a region of interest to which the night mode color process has been applied 132. The region of interest 132 may include distorted colors, image features that are imperceptible or difficult to perceive, and the like. The display device 102 may receive a user input 130 on a portion of the display device 102 presenting the region of interest 132. In some embodiments, in response to receiving the user input 130 on the portion of the display device 102 presenting the region of interest 132, the computing device may present a user interface element 134. The user interface element 134 may include an option 134a configured to enable or disable the application of the night mode color process to the region of interest, such as “deselect night light mode from image.” In response to receiving an input selecting the option to disable the application of the night mode color process to the region of interest, the computing device may apply a normal color process to the region of interest, and may display the region of interest 106, to which the night mode color process has not been applied.

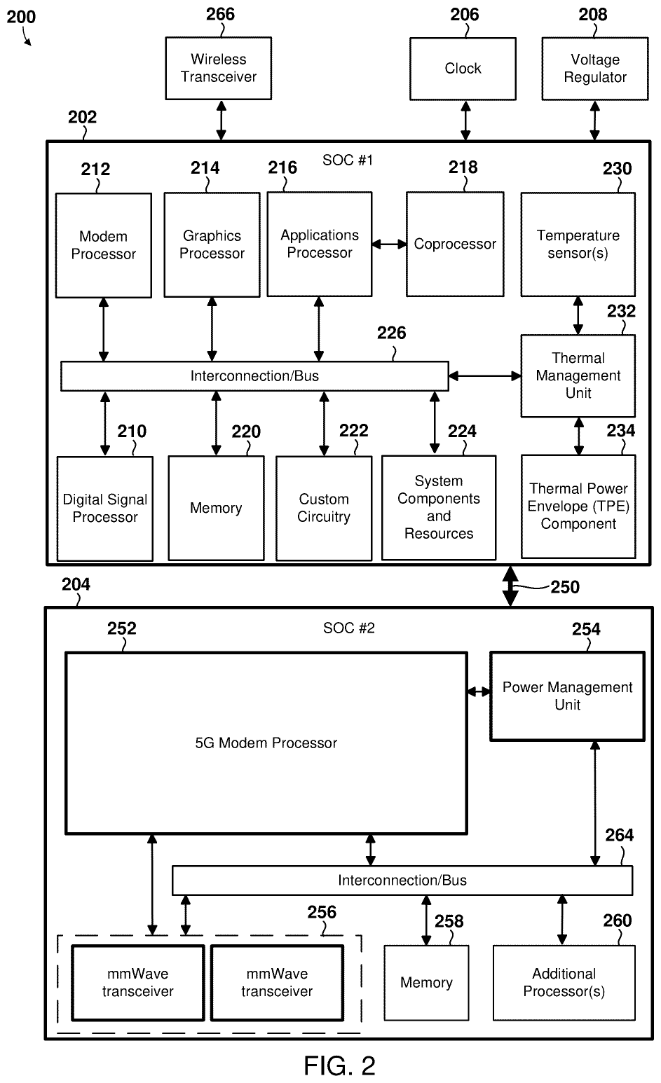

FIG. 2 is a component block diagram illustrating an example computing system 200 suitable for implementing various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some embodiments, the first SOC 202 may operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mm Wave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, the plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mm Wave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

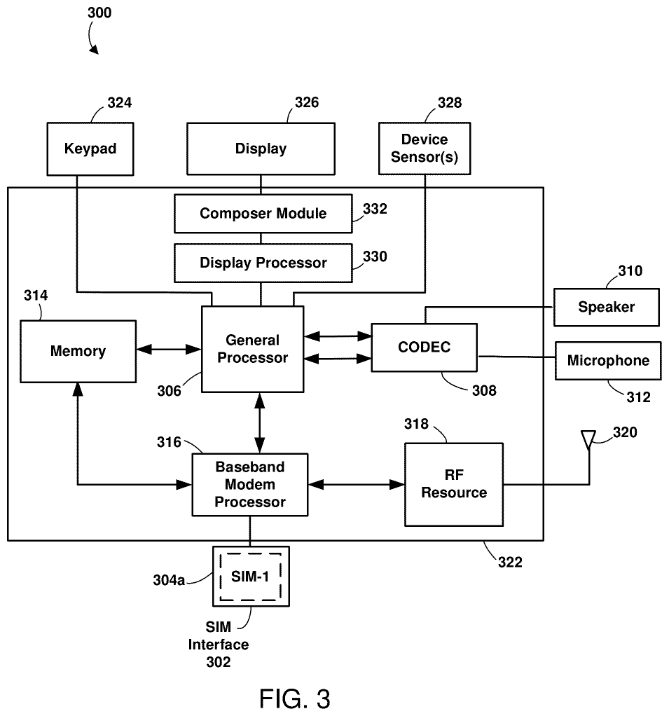

FIG. 3 is a functional block diagram of an example computing device 300 suitable for implementing various embodiments. With reference to FIGS. 1A-3, the computing device 300 may be similar to the computing device 100. For example, the computing device 300 may be a multi-SIM computing device, such as a multiple SIM multiple standby (MSMS) computing device. The computing device 300 may include at least one subscriber identity module (SIM) interface 302, which may receive a first SIM (“SIM-1”) 304a that is associated with a first subscription. In some embodiments, the at least one SIM interface 302 may be implemented as multiple SIM interfaces 302, which may receive at least a second that is associated with at least a second subscription.

A SIM in various embodiments may be a Universal Integrated Circuit Card (UICC) that is configured with SIM and/or universal SIM (USIM) applications, enabling access to a variety of different networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card.

Each SIM 304a may have a CPU, ROM, RAM, EEPROM and I/O circuits. One or more of the first SIM 304a and any additional SIMs used in various embodiments may contain user account information, an international mobile station identifier (IMSI), a set of SIM application toolkit (SAT) commands and storage space for phone book contacts. One or more of the first SIM 304a and any additional SIMs may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 304a for identification. In some embodiments, additional SIMs may be provided for use on the computing device 300 through a virtual SIM (VSIM) application (not shown). For example, the VSIM application may implement remote SIMs on the computing device 300 by provisioning corresponding SIM profiles.

The computing device 300 may include at least one controller, such as a general-purpose processor 306, which may be coupled to a coder/decoder (CODEC) 308. The CODEC 308 may in turn be coupled to a speaker 310 and a microphone 312. The general-purpose processor 306 may also be coupled to at least one memory 314. The memory 314 may be a non-transitory tangible computer readable storage medium that stores processor-executable instructions. For example, the instructions may include routing communication data relating to a subscription though the transmit chain and receive chain of a corresponding baseband-RF resource chain. The memory 314 may store operating system (OS), as well as user application software and executable instructions. The general-purpose processor 306 and memory 314 may each be coupled to at least one baseband-modem processor 316. Each SIM 304a in the computing device 300 may be associated with a baseband-RF resource chain that includes at least one baseband-modem processor 316 and at least one radio frequency (RF) resource 318.

The RF resource 318 may include receiver and transmitter circuitry coupled to at least one antenna 320 and configured to perform transmit/receive functions for the wireless services associated with each SIM 304a of the computing device 300. The RF resource 318 may implement separate transmit and receive functionalities, or may include a transceiver that combines transmitter and receiver functions. The RF resource 318 may be configured to support multiple radio access technologies/wireless networks that operate according to different wireless communication protocols. The RF resource 318 may include or provide connections to different sets of amplifiers, digital to analog converters, analog to digital converters, filters, voltage controlled oscillators, etc. Multiple antennas 320 and/or receive blocks may be coupled to the RF resource 318 to facilitate multimode communication with various combinations of antenna and receiver/transmitter frequencies and protocols (e.g., LTE, Wi-Fi, Bluetooth and/or the like).

The baseband-modem processor of a computing device 300 may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In some embodiments, the general-purpose processor 306, memory 314, baseband-modem processor 316, and RF resource 318 may be included in a system-on-chip device 322. The SIMS 304a and their corresponding interface(s) 302 may be external to the system-on-chip device 322. Further, various input and output devices may be coupled to components of the system-on-chip device 322, such as interfaces or controllers.

The computing device 300 may include a display device 326. The display device 326 may be coupled to a display processor 330 and a composer module 332. The display processor 330 may be configured (e.g., with processor-executable instructions) to identify a region of interest and a remainder region in a frame for display by the display device. The composer module 332 may be configured (e.g., with processor-executable instructions) to apply a night mode color process to the remainder region and not to the region of interest, and to provide a composition of the remainder region and the region of interest to the display device for presentation. The computing device 300 may include input devices such as a keypad 324 and a touchscreen input device included in the display 326 (e.g., 102).

In some embodiments, the general-purpose processor 306 may be coupled to one or more device sensors 328. The device sensor(s) 328 may provide an output that includes information about the environment around the computing device 300. For example, the computing device may include an ambient light sensor configured to sense and intensity of ambient light incident on the ambient light sensor, and to provide an output to the general-purpose processor 306 including information about the intensity of the ambient light.

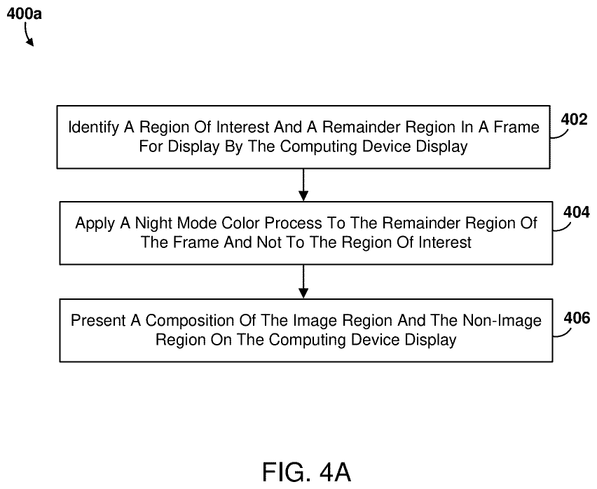

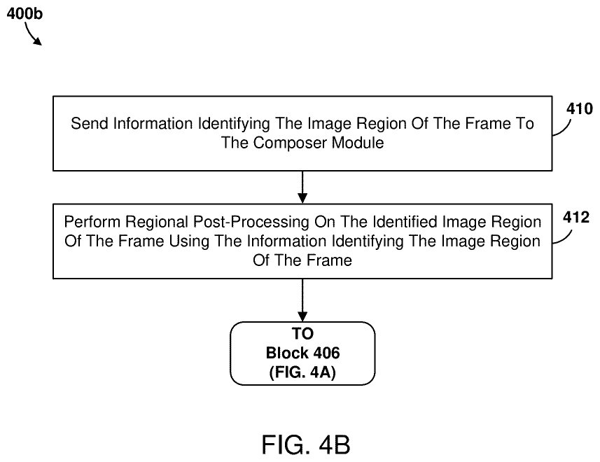

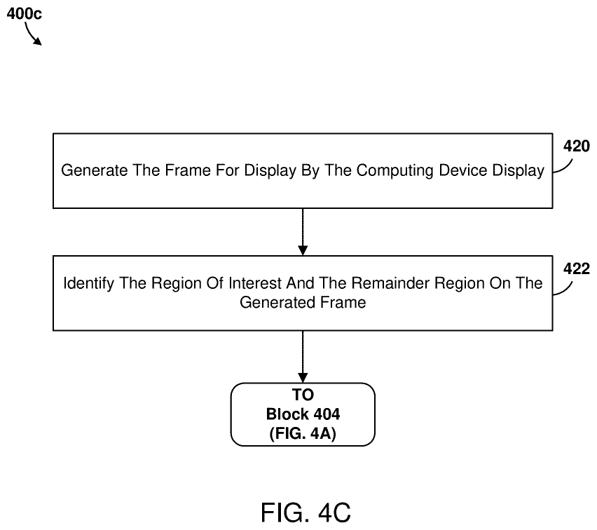

FIG. 4A illustrates a method 400a for selectively applying a night mode color process on a display device of a computing device according to various embodiments. With reference to FIGS. 1A-4A, means for performing the method 400a may include a processor (e.g., 210, 212, 214, 216, 218, 252, 260, 306, 330, 332) of a computing device (e.g., 100, 300), a display device (e.g., 102, 326), a display processor (e.g., 330, a composer module (e.g., 332), and a composer module 332 coupled to the display device and the display processor. To encompass any of the processors, hardware elements and software element that may be involved in performing the method 400a, the element or subsystems performing method operations are referred to generally as a “processor.”

In block 402, the processor may identify a region of interest and a remainder region in a frame for display by the computing device display. For example, a display processor may identify a region of interest and a remainder region in a frame for display by the display device.

In some embodiments, as part of the operations in block 402 the processor may apply a machine learning model to the frame for display to identify the region of interest of the frame, such as an image or a portion of an image in the frame. In such embodiments, the machine learning model may be trained to identify regions of images that users prefer to view in normal color mode. For example, the machine learning model may be trained using a training data set that indicates numerous examples of images that users prefer to view in normal color mode. In some embodiments, the training data set also may indicate examples of images that users prefer to view in night mode (i.e., with the night mode color process applied).

In block 404, the processor may apply a night mode color process to the remainder region of the frame and not to the region of interest. For example, a composer module may apply a night mode color process to the remainder region and not to the region of interest. In some embodiments, the processor may apply a normal color process to the region of interest. In some embodiments, the processor may provide a composition of the remainder region and the region of interest to the display device for presentation. In some embodiments, the processor may apply the normal color process in response to receiving a user input (for example, in a settings menu). In some embodiments, the processor may apply the normal color process in response to receiving a user input on a portion of the display device presenting the region of interest.

In block 406, the processor may present a composition of the region of interest and the non-image region on the computing device display. For example, a display device may present the composition of the remainder region to which the night mode color process has been applied and the region of interest to which the night mode color process has not been applied.

FIGS. 4B and 4C illustrate operations 400b and 400c that may be performed as part of the method 400a for selectively applying a night mode color process on a display device of a computing device according to various embodiments. With reference to FIGS. 1A-4C, means for performing the operations 400b and 400c may include a processor (e.g., 210, 212, 214, 216, 218, 252, 260, 306, 330, 332) of a computing device (e.g., 100, 300), a display device (e.g., 102, 326), a display processor (e.g., 330, a composer module (e.g., 332), and a composer module 332 coupled to the display device and the display processor. To encompass any of the processors, hardware elements and software element that may be involved in performing the method 400a, the element or subsystems performing method operations are referred to generally as a “processor.”

Referring to FIG. 4B, in block 410, the processor may send information identifying the region of interest of the frame to the composer module. For example, the processor may send information identifying an image region 106, 132 as the region of interest to the composer module (e.g., 332).

In block 412, the processor may perform regional post-processing on the identified image region of the frame using the information identifying the region of interest of the frame. For example, the composer module may perform regional post-processing on the identified image region of the frame using the information identifying the region of interest of the frame. In some embodiments, the regional post-processing may include applying a normal color process to the identified image region of the frame (e.g., the region of interest).

The processor may the processor may present a composition of the region of interest and the non-image region on the display device in block 406 of the method 400a as described.

Referring to FIG. 4B, in block 420, the processor may generate the frame for display (e.g., 104) by the computing device display.

In block 422, the processor may perform the identification of the region of interest and the remainder region on the generated frame.

The processor may apply a night mode color process to the remainder region of the frame and not to the region of interest in block 404 of the method 400a as described.

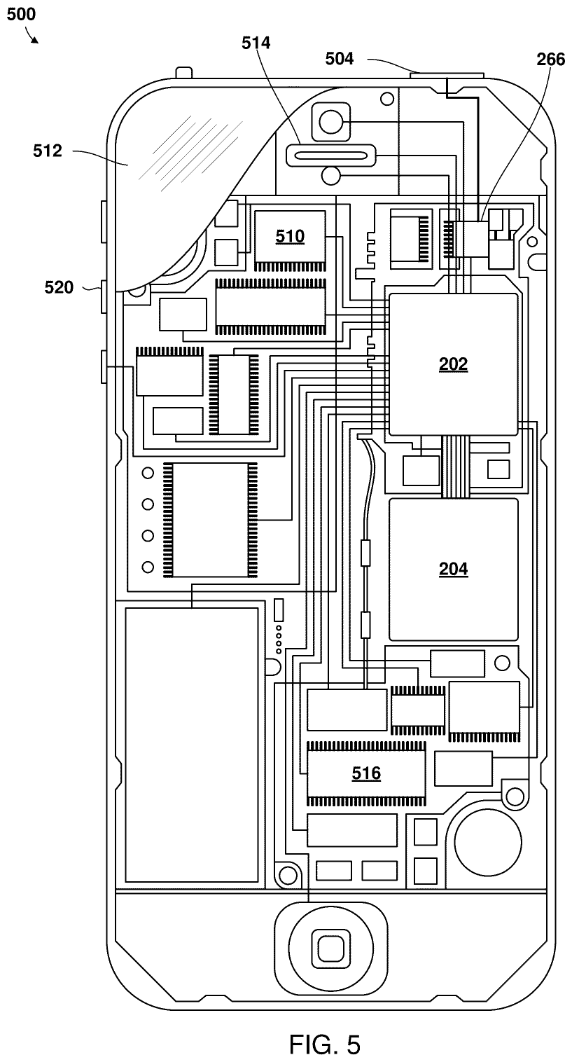

FIG. 5 is a component block diagram of a computing device 500 suitable for use with various embodiments. With reference to FIGS. 1A-5, the computing device 500 (e.g., 100, 300) may be configured to perform the operations of the methods and operations 400a-400c in various embodiments.

The computing device 500 may include a first SOC 202 (e.g., a SOC-CPU) coupled to a second SOC 204 (e.g., a 5G capable SOC). The first and second SOCs 202, 204 may be coupled to internal memory 516, a display 512, and to a speaker 514. Additionally, the computing device 500 may include an antenna 504 for sending and receiving electromagnetic radiation that may be connected to a wireless data link and/or cellular telephone transceiver 266 coupled to one or more processors in the first and/or second SOCs 202, 204. The computing device 500 may also include menu selection buttons or rocker switches 520 for receiving user inputs.

The computing device 500 also may include a sound encoding/decoding (CODEC) circuit 510, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 510 may include a digital signal processor (DSP) circuit (not shown separately).

The processors of the network computing device 500 and the computing device 500 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 516 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 400a-400c may be substituted for or combined with one or more operations of the methods and operations 400a-400c.

Implementation examples are described in the following paragraphs. While some of the following implementation examples are described in terms of example systems and methods, further example implementations may include: the example operations discussed in the following paragraphs may be implemented by various computing devices for controlling a display device that includes a display cutout; the example methods discussed in the following paragraphs implemented by computing device including a processor configured (e.g., with processor-executable instructions) to perform operations of the methods of the following implementation examples; the example methods discussed in the following paragraphs implemented by computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method for selectively applying a night mode color process on a computing device display, including identifying a region of interest and a remainder region in a frame for display by the computing device display, applying the night mode color process to the remainder region of the frame and not to the region of interest, and presenting a composition of the region of interest and the remainder region on the computing device display.

Example 2. The method of example 1, further including applying a normal color process to the region of interest.

Example 3. The method of either of examples 1 or 2, further including sending information identifying the region of interest of the frame to a composer module, in which applying a normal color process to the region of interest of the frame includes performing, by the composer module, regional post-processing on the identified region of interest of the frame using the information identifying the region of interest of the frame.

Example 4. The method of example 3, in which identifying the region of interest of the frame includes applying a machine learning model to the frame for display to identify the region of interest of the frame, in which the machine learning model is trained to identify regions of images that users prefer to view in normal color mode.

Example 5. The method of any of examples 1-4, further including generating the frame for display by the computing device display, in which identifying the region of interest and the remainder region is performed on the generated frame.

Example 6. The method of any of examples 1-5, in which applying a normal color process to the region of interest of the frame includes applying the normal color process in response to receiving a user input.

Example 7. The method of any of examples 1-6, in which applying a normal color process to the region of interest of the frame includes applying the normal color process in response to receiving a user input on a portion of the display device presenting the region of interest.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a display device;
a display processor configured to identify a region of interest and a remainder region in a frame for display by the display device; and
a composer module coupled to the display device and the display processor, and configured to apply a night mode color process to the remainder region and not to the region of interest, and to provide a composition of the remainder region and the region of interest to the display device for presentation.

2. The computing device of claim 1, wherein the composer module is further configured to apply a normal color process to the region of interest.

3. The computing device of claim 1, wherein:
the display processor is further configured to send information identifying the region of interest to the composer module, and
the composer module is further configured to apply a normal color process to the region of interest and the night mode color process to the remainder region using the information identifying the region of interest.

4. The computing device of claim 3, wherein the display processor is further configured to apply a machine learning model to the frame for display to identify the region of interest of the frame, wherein the machine learning model is trained to identify regions of images that users prefer to view in normal color mode.

5. The computing device of claim 1, wherein the display processor is further configured with processor-executable instructions to:
generate the frame for display by the display device; and
identify the region of interest and the remainder region on the generated frame.

6. The computing device of claim 1, wherein the composer module is further configured to apply a normal color process to the region of interest in response to receiving a user input.

7. The computing device of claim 1, wherein the composer module is further configured to apply a normal color process to the region of interest in response to receiving a user input on a portion of the display device presenting the region of interest.

8. A method for selectively applying a night mode color process on a computing device display, comprising:
identifying a region of interest and a remainder region in a frame for display by the computing device display;
applying the night mode color process to the remainder region of the frame and not to the region of interest; and
presenting a composition of the region of interest and the remainder region on the computing device display.

9. The method of claim 8, further comprising applying a normal color process to the region of interest.

10. The method of claim 8, further comprising:
sending information identifying the region of interest of the frame to a composer module,
wherein applying a normal color process to the region of interest of the frame comprises performing, by the composer module, regional post-processing on the identified region of interest of the frame using the information identifying the region of interest of the frame.

11. The method of claim 10, wherein identifying the region of interest of the frame comprises applying a machine learning model to the frame for display to identify the region of interest of the frame, wherein the machine learning model is trained to identify regions of images that users prefer to view in normal color mode.

12. The method of claim 8, further comprising:
generating the frame for display by the computing device display,
wherein identifying the region of interest and the remainder region is performed on the generated frame.

13. The method of claim 8, wherein applying a normal color process to the region of interest of the frame comprises applying the normal color process in response to receiving a user input.

14. The method of claim 8, wherein applying a normal color process to the region of interest of the frame comprises applying the normal color process in response to receiving a user input on a portion of the computing device display presenting the region of interest.

15. A computing device, comprising:
a display;
means for identifying a region of interest and a remainder region in a frame for display by the display;
means for applying a night mode color process to the remainder region of the frame and not to the region of interest; and
means for presenting a composition of the region of interest and the remainder region on the display.

16. The computing device of claim 15, further comprising means for applying a normal color process to the region of interest.

17. The computing device of claim 15, further comprising:
means for sending information identifying the region of interest of the frame to a composer module,
wherein means for applying a normal color process to the region of interest of the frame comprises means for performing, by the composer module, regional post-processing on the identified region of interest of the frame using the information identifying the region of interest of the frame.

18. The computing device of claim 17, wherein means for identifying the region of interest of the frame comprises means for applying a machine learning model to the frame for display to identify the region of interest of the frame, wherein the machine learning model is trained to identify regions of images that users prefer to view in normal color mode.

19. The computing device of claim 15, further comprising:
means for generating the frame for display by the display,
wherein means for identifying the region of interest and the remainder region comprises means for identifying the region of interest and the remainder region on the generated frame.

20. The computing device of claim 15, wherein means for applying a normal color process to the region of interest of the frame comprises means for applying the normal color process in response to receiving a user input.

21. The computing device of claim 15, wherein means for applying a normal color process to the region of interest of the frame comprises means for applying the normal color process in response to receiving a user input on a portion of the computing device display presenting the region of interest.

22. A non-transitory processor-readable medium having stored thereon processor-executable instructions configured to cause a processing device in a computing device to perform operations comprising:
identifying a region of interest and a remainder region in a frame for display by the computing device display;
applying a night mode color process to the remainder region of the frame and not to the region of interest; and
presenting a composition of the region of interest and the remainder region on the computing device display.

23. The non-transitory processor-readable medium of claim 22, wherein the stored processor-executable instructions are further configured to cause the processing device in the computing device to perform operations further comprising applying a normal color process to the region of interest.

24. The non-transitory processor-readable medium of claim 22, wherein the stored processor-executable instructions are further configured to cause the processing device in the computing device to perform operations further comprising:
sending information identifying the region of interest of the frame to a composer module,
wherein applying a normal color process to the region of interest of the frame comprises performing, by the composer module, regional post-processing on the identified region of interest of the frame using the information identifying the region of interest of the frame.

25. The non-transitory processor-readable medium of claim 24, wherein the stored processor-executable instructions are further configured to cause the processing device in the computing device to perform operations such that identifying the region of interest of the frame comprises applying a machine learning model to the frame for display to identify the region of interest of the frame, wherein the machine learning model is trained to identify regions of images that users prefer to view in normal color mode.

26. The non-transitory processor-readable medium of claim 22, wherein the stored processor-executable instructions are further configured to cause the processing device in the computing device to perform operations further comprising:
generating the frame for display by the computing device display,
wherein identifying the region of interest and the remainder region is performed on the generated frame.

27. The non-transitory processor-readable medium of claim 22, wherein the stored processor-executable instructions are further configured to cause the processing device in the computing device to perform operations such that applying a normal color process to the region of interest of the frame comprises applying the normal color process in response to receiving a user input.

28. The non-transitory processor-readable medium of claim 22, wherein the stored processor-executable instructions are further configured to cause the processing device in the computing device to perform operations such that applying a normal color process to the region of interest of the frame comprises applying the normal color process in response to receiving a user input on a portion of the computing device display presenting the region of interest.
